(19) United States
(12) Patent Application Publication
(10) Pub. No.: US 2008/0177600 A1
(43) Pub. Date: Jul. 24, 2008

(54) METHODS AND SYSTEMS FOR MEASURING ONLINE CHAT PERFORMANCE

(76) Inventors: Michael Sean McCarthy, Simi Valley, CA (US); Donna Cohen, Sherman Oaks, CA (US); Daniel R. McManus, Tajunga, CA (US); Jim Van Baalen, Santee, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/971,677

(22) Filed: Jan. 9, 2008

Related U.S. Application Data
(60) Provisional application No. 60/879,456, filed on Jan. 9, 2007.

(51) Int. Cl. G06Q 10/00; G06F 15/177

(52) U.S. Cl. 705/7; 715/736

(57) ABSTRACT

Methods and systems for measuring chat performance are described. Certain users accessing a website are inhibited by a chat system from receiving online chat service, while other users are provided with online chat service, wherein users can textually communicate with another entity. Optionally, the chat system causes web beacons or other activity trackers to be downloaded to terminals associated with website visitors. The beacons provide website activity information for respective users. The chat system or another system monitors and processes the website activity information, to determine or provide information for determining chat performance.

### CROSS-REFERENCE TO RELATED APPLICATIONS

The present application claims priority from U.S. Patent Application No. 60/879,456, filed Jan. 9, 2007, the content of which is incorporated herein in its entirety.

### STATEMENT REGARDING FEDERALLY SPONSORED R&D

Not applicable.

### PARTIES OF JOINT RESEARCH AGREEMENT

Not applicable.

### REFERENCE TO SEQUENCE LISTING, TABLE, OR COMPUTER PROGRAM LISTING

Not applicable.

### BACKGROUND OF THE INVENTION

1. Field of the Invention

The present invention is related to measuring the performance of communications conducted over a network, and in particular to measuring chat performance.

2. Description of the Related Art

Online chat has been increasingly used to enable website agents to communicate with website visitors. For example, online chat is sometimes used to help a visitor complete a purchase or to identify a product the visitor may be interested in.

However, conventional chat systems fail to provide an adequate measure as to the performance of their chat services.

### SUMMARY OF THE INVENTION

Systems and methods are described that can be utilized to measure the effectiveness of an online chat service, such as a chat service hosted on a website. By way of illustration, a chat service may be provided as a one-on-one text-based chat or text-based group chat. The chat service may be provided using instant messaging applications. An example chat service provides a user with the ability to at least textually chat with a customer service representative (also referred to as an agent).

For example, effectiveness is optionally measured as increases in the achievement of one or more website goals which may be the result of providing an online chat service. A website goal may relate to the utilization by users of services offered by the website and/or purchases of items from the website.

An example embodiment provides a measure as to the effectiveness of a chat service by estimating changes facilitated by the use of the chat service (relative to instances where chat is not offered) in gross sales, incremental changes in units sales and/or the rate at which visitors are converted into customers. Thus, phantom chat can be used to quantify and compare the effectiveness of a web site with and without chat.

An example embodiment provides a method of measuring networked chat performance, the method comprising: assigning a first subset of visitors to a website to a first group, the first group associated with a first set of one or more chat initiation rules; assigning a second subset of visitors to the website to a second group, the second group associated with a second set of one or more chat initiation rules; receiving and storing conversion related information for the first group; receiving and storing conversion related information for the second group; and causing at least in part the conversion related information for the first group and the conversion related information for the second group to be processed so as to provide information as to relative effectiveness of the first set and the second set in causing conversions.

### BRIEF DESCRIPTION OF THE DRAWINGS

Illustrative embodiments will be described with reference to the drawings summarized below. These drawings and the associated description are provided to illustrate example embodiments, and not to limit the scope of the invention.

FIG. 1 illustrates an example system architecture and a first example process flow.

FIG. 2 illustrates another example process flow.

FIGS. 3-5 illustrate example reports.

### DETAILED DESCRIPTION OF PREFERRED EMBODIMENTS

Systems and methods are described that can be utilized to measure the effectiveness of an online chat service, such as a chat service hosted on a website.

In an example embodiment, phantom chat is used to measure or compare effectiveness of a population of visitors (e.g., customers or prospects for services, products, and/or information offered via a website) that is exposed to chat in achieving web site goals against a control group (visitors that are not exposed to chat). This comparison may be made for all visitors to a website or for a select subset of visitors.

A chat service may be provided as a one-on-one text-based chat or text-based group chat. In an example embodiment, a chat client on a user terminal provides a user interface including an input area in which a user can type in a message (e.g., a request for help or information). The message is transmitted to an agent in substantially real time. The agent can then respond to the user (e.g., to the user's request for help or information), where the response will be displayed to the user in substantially real time via the chat client. An example chat service provides a user with the ability to at least textually chat (e.g., with a customer service representative/agent). By way of example and not limitation, the chat client can be implemented using Adobe Flash technology, HTML, Java applets, and/or other technologies.

Chat service effectiveness is optionally measured with respect to the goals of an operator of a given website. In an example embodiment, relative effectiveness is optionally measured as the percentage of visitors to a website who achieve a specified goal of the website operators when chat service is provided as compared to the percentage of visitors to a website who achieve the specified goal when chat service is not provided.

Different websites may be associated with different goals or sets of goals (which may be overlapping). For example, some websites' goals may be associated with information gathering, some websites' goals may be associated with having a user make a purchase of a good or service, some websites' goals may be associated with having a user click certain links, view certain pages or other media, request certain types of information, etc. By way of illustration, business website-types may be directed to one or more of the following:

commerce, with the goal of having visitors purchase goods and/or services;

lead generation, with the goal of having a visitor provide data via an online form related to the visitors interests;

media, with the goal of having a visitor view certain media;

support, with the goal of aiding a visitor with respect to utilizing a service or product.

By way of example, effectiveness may be measured with respect to increases/decreases in the utilization by users of services offered by the website and/or increases in sales resulting (or likely resulting) from providing access to a chat service.

In particular, an example embodiment provides a measure as to effectiveness of a chat service by estimating changes facilitated by the use of the chat service in terms of changes in gross sales, incremental sales, the rate at which visitors are converted into customers, customer satisfaction, and/or opt-in by customers to receive future marketing communications (e.g., via email, SMS, MMS, etc). Such measurements may be provided by obtaining and providing comparison information with respect to instances where chat is provided (e.g., where a website user textually communicates with a website representative in substantially real time) and instances where chat is not provided. Such comparisons can further be performed with respect to different funnels and/or with respect to different chat launch business rules.

Phantom chat is one technique for performing such a comparison. As will be described in greater detail below, phantom chat can be provided to a control group of subjects which does not receive the chat “experience” during visits to a website on which a phantom chat test is running, but in other respects is treated in substantially the same way as users that are provided with a chat experience (e.g., members of the control group view substantially the same content as users that are provided with a chat experience (the chat enabled group), except that members of the control group are not presented with the chat application, so as to reduce or eliminate other variables between the two groups). Thus, phantom chat can be used to quantify and compare the effectiveness of a web site with and without chat.

Effectiveness evaluation can be performed for selected sets of visitors, wherein a selected set may include, by way of example and not limitation, all visitors or a selected percentage of visitors that intersect a specified subset of a website's content (e.g., certain specified web pages), or all visitors or a selected percentage of visitors that satisfy a behavior, demographic, or other type of condition (e.g., a chat launch business rule).

In discussing example embodiments, the term “Web site” is used to refer to a user-accessible server site that implements the basic World Wide Web standards for the coding and transmission of hypertextual documents. These standards currently include HTML (the Hypertext Markup Language) and HTTP (the Hypertext Transfer Protocol). It should be understood that the term “site” is not intended to imply a single geographic location, as a Web or other network site can, for example, include multiple geographically-distributed computer systems that are appropriately linked together. Furthermore, while the following description relates to an embodiment utilizing the Internet and related protocols, other networks, such as networked interactive televisions, and other protocols may be used as well.

In addition, unless otherwise indicated, functions described herein are preferably performed by software including executable code/program instructions running on one or more computers. The computers can include one or more central processing units (CPUs) that execute program code and process data, memory, including one or more of volatile memory, such as random access memory (RAM) for temporarily storing data and data structures during program execution, non-volatile memory, such as a hard disc drive, optical drive, or FLASH drive, for storing programs and data, including databases, which may be referred to as a “system database,” and a network interface for accessing an intranet and/or Internet. In addition, the computers can include a display via which user interfaces, data, and the like can be displayed, and one or more user input devices, such as a keyboard, mouse, pointing device, microphone and/or the like, used to navigate, provide commands, enter information, provide search queries, and/or the like.

However, the present invention can also be implemented using special purpose computers, terminals, state machines, and/or hardwired electronic circuits. In addition, the example processes described herein do not necessarily have to be performed in the described sequence, and not all states have to be reached or performed. While personal computers or laptops may be referenced herein, other terminal types can be used as well, such as interactive televisions, phones, etc.

In addition, while reference may be made to certain programming languages, such as JavaScript (a scripting language that is typically executed by a client side application, such as a web browser), other types of programming languages may be used as well (e.g., VBScript, AJAX (Asynchronous JavaScript and XML), etc.).

As discussed above, phantom chat employs the concept of measuring a population of visitors that are exposed to chat against a control group (visitors that are not exposed to chat for the duration of a phantom chat test, even though a chat enabled group member would be provided with chat under similar circumstances). This comparison may be made for all visitors to a website or a select subset of visitors. Ways in which a set of visitors to a website can be selected include, but are not limited to, all visitors, all visitors (or a percentage thereof) that intersect a subset of a website's content, all visitors (or a percentage thereof) that satisfy a behavior, demographic or other type of condition (e.g., a chat launch business rule).

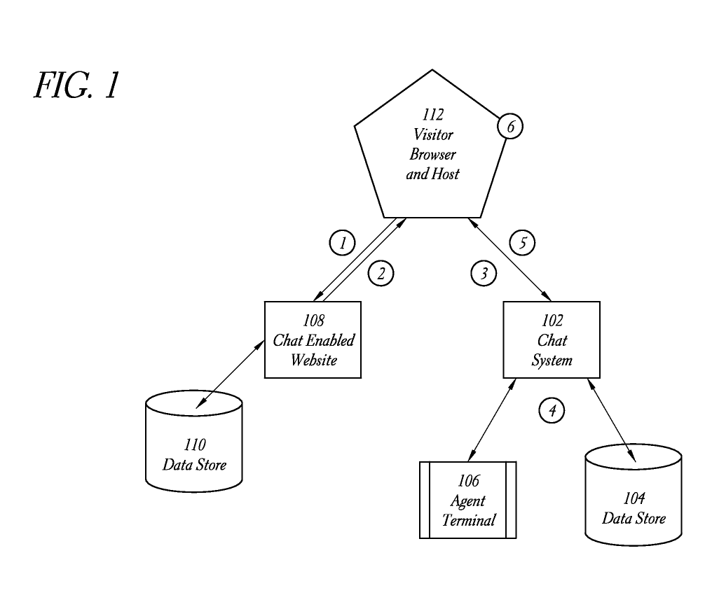

FIG. 1 illustrates an example configuration including:

a chat enabled website 108;

a chat system 102, including one or more chat servers, agent terminals 106, and a chat database 104;

one or more visitor applications, such as a browser 112, that can be used to access and/or provide information over a network (e.g., hosted on one or more terminals, such as a personal computer, interactive television, phone, etc.);

The chat system 102 can include network interfaces (e.g., data interfaces to the Internet) used to communicate with the chat enabled website 108 and the visitor browser 112. Optionally, the chat system 102 can access information (e.g., information regarding a website visitor, such as demographic and purchase history information) stored in the chat enabled website database 110. The chat system 102 optionally also includes an administration server.

The chat service may be provided by the chat system 102 using instant messaging applications. By way of example and not limitation, the chat service can be provided using Internet Relay Chat, MUCKs, MUSHes and MOOes, or other technology.

The chat enabled website 108 can include one or more Web servers (that accepts HTTP requests from clients, such as web browsers, and serves HTTP responses in addition to optional data contents, such web pages (e.g., HTML documents and linked objects, such as images), and that receive user inputs), databases 110, and interfaces (e.g., data interfaces to the Internet) used to communicate with the chat system 102 and the visitor browser 112.

By way of example, the chat server is optionally implemented as a socket-based server (e.g., coded using Java, Perl, C++, and/or other language) which controls communication between the chat client used by a visitor and an agent (e.g., a person who acts on behalf of the website operator to promote one or more goals associated with the website, such as a customer service person), where the agent uses a terminal 106 to interact with the end user. The agent terminal can be, by way of example, a browser enabled computer, and can be the same type as, or a different type than the visitor terminal. By way of further example, the chat server can be implemented using other client server protocols such as JMS (Java Message Service), MQ, etc.

The chat service provided via the chat servers receives, acts on and/or collects data regarding visitors. The chat server may utilize an operating system such as Unix, Linux, Solaris, a Windows-based operating system, an OS X based operating system, or other operating system. The chat service can receive from and/or provide information to the chat enabled website 108. The chat service optionally determines when to launch a chat, performs a chat launch accordingly, connects a site visitor who has interacted with a chat client to an agent and/or records site conversions.

Optionally, the chat service provides a visitor with a context-sensitive first interaction that appears to originate from a human chat agent but actually is automatically provided by the chat service (e.g., an initial automated chat greeting, such as “Hello, can I help you or answer any questions?”). When and if the visitor responds to the initial chat communication from the chat service, the visitor is then “connected to” a human chat agent (if one is available) for further chat interaction.

The chat database 104 (e.g., a MYSQL, Oracle, Sybase, MSSQL, or other type of database) can store some or all of the following information and/or different information, which may be obtained via a chat beacon, chat cookie, other tracking mechanism, another database, or otherwise:
a unique identifier associated with a given visitor;
a unique identifier associated with the visitor's browser;
referring information, including some or all of the following:
   referring domain (e.g., the domain of the web site that the user visited just before they accessed the chat enabled website 108, where, for example, the referring domain is an advertising partner or a web page with a link to the chat enabled website 108, wherein the user activated the link to access the website 108);
   referring keyword (e.g., a keyword used by the visitor leading to the chat enabled site via an Internet search engine or directory);
   campaign data (e.g., indicating which advertising campaign or program referred the visitor to the chat enabled website 108);
website behavior, such as visitor navigation information on the chat enabled website 108, including some or all of the following:
   number of visits to the chat enabled website 108;
   time spent on the website 108;
   content interest (e.g., as measured by time spent on a given website page having certain content, search terms used, number of returning visits to a given page, etc.);
the Internet Service Provider associated with the visitor;
demographic information (e.g., generated based on IP address or provided by the chat enabled website database based on prior knowledge of the visitor) including, but not limited to some or all of the following:
   location of the visitor (e.g., country, state, city);
   language of the visitor;
   gender of visitor (which may be obtained directly from the visitor via a form or may be obtained from a user account database associated with the website);
   age of visitor;
   income of visitor;
website specific visitor interaction data (e.g., data a visitor provides via forms and/or other applications on a website that may be indicative of their interests).

In an example embodiment, program code (e.g., in the form of JavaScript, Macromedia Flash, etc.) is embedded in a web page (e.g., a web page associated with an online catalog via which the user can order products and/or services) accessed by a user. For example, the program code may be utilized to write functions that are embedded in or included from HTML pages and interact with the Document Object Model (DOM) of the browser. The program code is optionally provided by the chat system 102 although it may be provided via another system. For example, the program code may provide a tracking mechanism, such as a chat beacon, that enables communication between a visitor's browser or other website content consuming application and the chat service provider, which, for example, can monitor the behavior of the person visiting the website 108.

By way of example and not limitation, the beacon can be JavaScript or a small (e.g., 1×1 pixel) transparent image (or an image of the same color of the background) that is embedded in a web page (e.g., an HTML page), or implemented using an HTML iframe, style, script, input link, embed, object, and/or tags to track usage. When the user/visitor accesses the web page, the beacon is embedded in the web page. The chat beacon instructs the browser to connect to the chat server. During this connection information about the visit/visitor can be passed to the chat server. The chat server can store this information in the chat database and/or return instructions to the web browser (e.g., launch a chat).

By way of illustration, JavaScript or other code can be embedded in the chat enabled website 108 to establish communication, launch a chat, track a user, and/or set a cookie. The beacon can provide information, such as some or all of the following: the IP address of the computer that retrieved the beacon, the time the beacon was executed and for how long, the type of browser that retrieved the beacon, previously set cookie values, etc. In addition, a beacon/tag can be embedded in a website order confirmation page which informs the appropriate server that a purchase has been made, thereby enabling sales to be tracked and measured.

In an example embodiment, the beacon/tag calls the chat system 102 (e.g., a chat server) to initiate a chat. The chat system 102 accesses configuration instructions to determine, at least in part, whether an actual chat or a phantom chat is to take place.

If phantom chat is selected, then phantom chat code (e.g., in JavaScript), a timer and cookie are returned by the chat server to the requesting browser 112. The phantom chat JavaScript, timer and cookie are written to the visitor/user web browser 112 by the beacon or during the interaction between the web beacon and the chat service. The phantom chat cookie can store information including, but not limited to some or all of the following: a unique identifier, a phantom chat test/group identifier, visitor behavior and demographic data. The customer may then complete (in whole or in part) the order process (e.g., to purchase a good or service via the Web site). If the user reaches a certain designated point in the process, such as the sales confirmation web page, the phantom chat cookie is passed back to the server when the confirm sales JavaScript tag is executed.

Referring again to FIG. 1, an example chat launch process will now be described. While the chat system 102 and the chat enabled website 108 are illustrated as two separate systems (and optionally operated by two different entities), optionally, the website and chat system 102 are hosted on the same computer system and operated by the same entity.

At state 1, a visitor requests a URL (e.g., by entering the URL into a browser address field of the browser 112, by activating a link associated with the URL, by performing a search which causes the URL to be requested, or otherwise) for content (e.g., a web page) in which the web beacon for the chat system 102 is embedded. The URL is transmitted over a network (e.g., the Internet) and received by the chat enabled website 108, thereby initiating the chat launch process.

At state 2, the content (e.g., a web page) associated with the URL is returned from the chat enabled website 108 and loaded into the visitor's browser 112. In this example, the content includes the web beacon.

At state 3, the beacon is executed by the visitor's browser 112 and a request is made via the browser 112 to the chat system 102. This request is used to pass information to the chat service. The information may include referring information, data based on website specific visitor interaction, demographic information, or other useful information. This information can be stored in a cookie and/or the chat database, passed to an agent (if an active chat exists) and/or analyzed (by a chat launch rule) for the purposes of determining whether to launch a chat.

At state 4, the chat system passes relevant information to the agent and/or the chat system data store 104. This information can include some or all of the information passed to the chat server when the beacon is executed (e.g., referring information, data based on website specific visitor interaction, demographic information, or other useful information).

At state 5, the chat system 102 responds to the visitor's browser request. By way of example, the response can include cookies, one or more files (e.g., an extension of the chat system used for applying rules, files to be used when launching a chat, etc., wherein the files maybe JavaScript, Flash, or other), etc.

At state 6, if the chat system 102 determines that a chat session is to be initiated (e.g., if certain rules stored in the chat data store 104 or elsewhere are satisfied), a chat launch is returned by the system 102 and a chat user interface is rendered in the visitor's browser 112. Example conditions/factors that can trigger a chat can include one or more of the following (although other conditions/factors can be used):
a. Time on a page (which may indicate a visitor is particularly interested in the page content or needs help). For example, if a user has stayed on the same web page for a specified time period (e.g., a time period specified by a value stored in the chat system data store), then chat may be triggered.
b. Sequence of web pages visited. For example, if the system determines that a user has visited specified pages (e.g., as identified by indicators stored in cookies or the chat server data store), optionally in a specified order, or not visited a specific page or pages within a sequence during a session or period of time, then the chat system 102 causes a chat to be initiated when the user visits a specified page.
c. Number of times the user has visited a page, optionally within a specified period of time (which may indicate a visitor is particularly interested in the page content or needs help). For example, if a user has returned to a certain page or pages at least a specified number of times (e.g., substantially immediately, across a specified number of unique days, or across a specified number of unique sessions), or if the user has not visited a certain page or pages within a session or a period of time, the chat system 102 causes a chat to be initiated the next time the user visits the page.
d. Exit from a specified web page (which may indicate a visitor needs help). For example, if the system detects that the user has exited from a certain web page (e.g., identified in the system data store), such as by closing the user's browser 112, pressing a browser back button, selecting another place on the site to go by using the sites' navigation or by entering a new URL into the browser's address field, then the system causes a chat to be initiated.
e. A halt in completing a form (which may indicate a visitor needs help or encouragement). For example, if the chat system 102 detects that a user started to complete a web-based form, and then stopped for a specified time period (e.g., 10 seconds, 20 seconds, 25 seconds, or other period of time specified in a system data store) or exited the page without completing the form, or if the user skips certain fields in a form, or enters inaccurate information, or enters conflicting data, the chat system 102 automatically or in response to an operator instruction causes a chat to be initiated.
f. Other behavioral information (e.g., related to the visitor's actions on the chat enabled website and/or prior to visiting the website).
g. Referring information such as search terms, campaign information, referring domain, and/or other types of referring information.
h. Demographic information related to the visitor, such as age, gender, salary range, profession, marital status, geographical location, and/or other demographic information.
i. Existing customer account information, such purchase history, product interests, type of payment mechanism used (e.g., credit card, debit card, etc.) and/or other account information.
j. Custom data collected via website interactions, such as internal search terms (search terms used by the visitor to search for information on the chat enabled website), other forms and other custom web applications with which visitors interact and provide information about themselves.

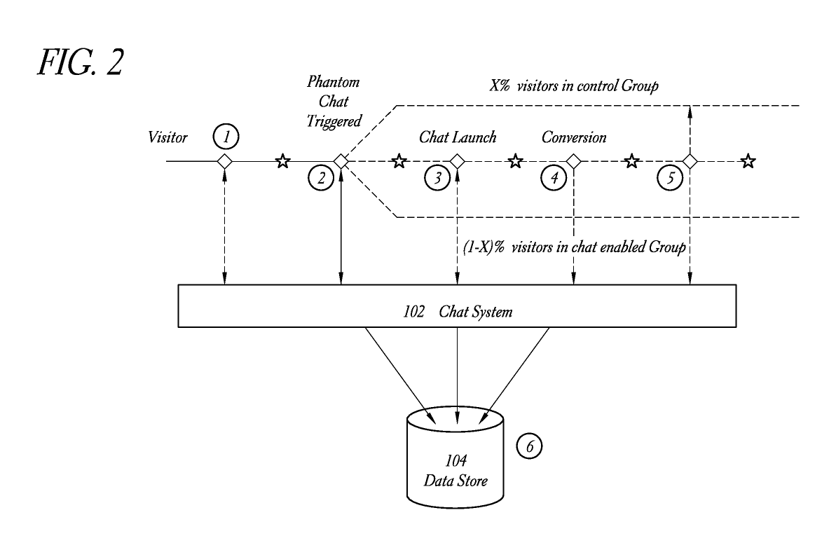

FIG. 2 illustrates an example phantom chat process used to measure or provide information regarding the improvement in goal achievement that is or may be attributable to providing website visitors with chat.

At state 1, a visitor's browser 112 loads content, including a chat beacon stored on the chat enabled website 108. The chat beacon can be embedded on a web page being accessed by the browser. The chat beacon enables the chat system 102 to begin to track the behavior of the visitor. Some or all of the following information and/or different information is tracked and collected the by chat system:
referring information (e.g., referring domain, keyword, campaign data, etc.);
website behavior (number of visits, content interests, time spent on site, etc);
demographic information (e.g., such as age, gender, income, marital status, etc., generated based on the visitor's IP address or provided by the chat enabled website based on prior knowledge of the visitor, such as knowledge collected when the user registered at the website and/or based on user purchases, browser patterns, etc.);
purchase history information (e.g., provided by the chat enabled website);
data based on website specific visitor interaction (e.g., data that a visitor provides via forms and/or other applications on a website that may be indicative of their interests).

At state 2, the visitor loads a page that includes a chat beacon that triggers a phantom chat test. The visitor is added to the population included in the test. In this example, a defined percentage of visitors who satisfy the conditions of the test will be placed in a control group. Other visitors that satisfy the conditions of the test will be placed in the “chat enabled group”. Visitors in the chat enabled group are eligible for, but are not necessarily offered, a chat session. A phantom chat cookie is stored in the visitor's browser recording the visitor's inclusion in the phantom chat test and in which group (control or non-control) the visitor has been placed.

The determination as to whether the chat for a given visitor is to be a real chat (e.g., where the user will interact with an agent) or a phantom chat (where the user will not actually engage in a textual interaction with an agent but whose actions or lack thereof will be tracked) can be based on one or more of the following example factors and/or other factors:

a. A specified percentage of total visitors (e.g., during the specified period of the phantom chat test as defined by a start and optionally an end date) that are to be included in the phantom chat control group (e.g., a percentage stored in the system data store, such as 5%), where the control group members are randomly selected from website visitors (that are included in the test) to make up the specified percentage or are selected based on other criteria;

b. A visitor's inclusion in a phantom chat test occurs when they satisfy the conditions of the test. These conditions may include, but are not limited to being eligible for chat, intersecting the appropriate area of content in which the test is active, satisfying a chat launch rule, etc.

c. At a specified chat interval (e.g., every 100^{th} chat, every 20^{th} chat, etc.);

d. At one or more specified times or time intervals (e.g., at the beginning of every hour, once in the morning once in the evening, between 11:00 AM and 12:00 PM, every Wednesday, etc.);

e. Phantom chats can be selected randomly/pseudo randomly;

f. Based on conversion rates of website visitors to customers; and/or

g. Other variables.

Phantom chats can also be manually enabled. For example, a system operator can activate a physical switch or a softswitch accessed via a computer terminal in order to turn a chat on or off for a given visitor or all visitors or period of time.

Visitors in the chat enabled group are eligible for, but do not necessarily engage in, a chat session enabling them to communicate with an agent (e.g., wherein the agent communicates via the agent terminal 106).

When a visitor is included in a phantom chat test some or all of the following attributes may be assigned to the visitor whether the visitor is in the control or non-control group: a phantom chat test ID, a funnel ID and/or a rule ID. This information may be stored on a browser, in the chat database or elsewhere.

At state 3, a chat session is launched. If the visitor is in the chat enabled group, the visitor may request or be offered (if/and when the visitor triggers or satisfies a chat launch rule) an opportunity to chat with an agent. In an example embodiment, a visitor can request a chat via a chat launch control (e.g., via an icon, such as a “click to launch” button) presented via the visitor's browser 112. Optionally, the chat launch control is not displayed (or is displayed but not operable) for those visitors that are in the control group, and the chat launch control is displayed and available for those users in the chat enabled group. By way of example, the launch rule can enable or trigger a chat based on referring, behavior, demographic and/or other information that is available regarding a visitor.

When the visitor trigger occurs, and a chat process is launched, a chat user interface is presented and/or enabled. For example, an inline chat user interface is presented in the web page being viewed. Optionally, a pop-up window including the chat user interface can overlay the web page being viewed. Optionally, the chat user interface may be presented via a pop-up window and if the user elects to chat, the chat user interface converts to an inline chat user interface. By way of further example, the chat user interface can be presented in a new window.

In an example embodiment, if the visitor elects to chat (or if a chat is initiated with the visitor), text entered by an agent via the agent terminal 106 will appear on the visitor's chat interface in substantially real time, and text entered by the visitor in the visitor's chat user interface will appear on the agent's chat user interface in substantially real-time.

At state 4, a determination/inference is made as to whether the visitor was “converted” (e.g., took an action which achieved a goal associated with the chat enabled website, such as making a purchase from the website or filling out a form presented via the web site), also referred to as a conversion event.

Optionally, the chat system monitors whether a conversion event occurred within a specified time period (sometimes referred to herein as a rechat interval) after chat occurred (e.g., after the chat was initiated or after the chat session ended). Information related to the event (e.g., a list of items purchased, the cost of each item, forms filled out, and/or other information) is passed to the chat system 102 via the chat beacon.

In an example embodiment, the rechat interval is stored in the visitor cookie. The rechat interval specifies the period that the chat system waits before another proactive chat can be initiated (although the visitor can initiate a chat within the rechat interval). For example, the rechat interval may be set so as not to annoy a visitor with too many offers to chat in to short a period of time. By way of illustration, the rechat interval can be set to 3 days, 7 days, or other period of time. Optionally, if a visitor is converted, a rechat interval is not set. In order to be consistent, optionally the same interval is applied to phantom chat. This means that a visitor who has been placed in the control group can be reclassified (placed in the chat enabled group) after the rechat interval has expired.

For example, if the customer chooses to purchase a product and completes the order flow pages of a client's web site, then the customer will encounter another beacon/tag (e.g., embedded on an order confirmation page) that will inform the chat system 102 that a sale has taken place and may optionally pass a product identifier, quantity and/or value of the sale to the chat system 102 along with the phantom chat test ID.

If a conversion event occurs within the rechat interval time period, an inference is made that the conversion is or may be attributable to the chat session.

If a visitor is in the control group, and is provided with phantom chat, if and when a conversion event is reached by a visitor within the given time limit and before the phantom chat test expires, information about the event, such as the conversion, a list of items purchased, the cost of each item, forms filled out, and/or other information is passed to the chat system 102 via the chat beacon.

At state 5, additional conversion events may occur. Thus, it is possible for a visitor to convert (e.g., make a purchase) more than one time from a given website. If multiple conversions occur within the allotted conversion time period (e.g., the rechat interval or other specified interval), optionally the system is configured to attribute the conversion events to the same chat session.

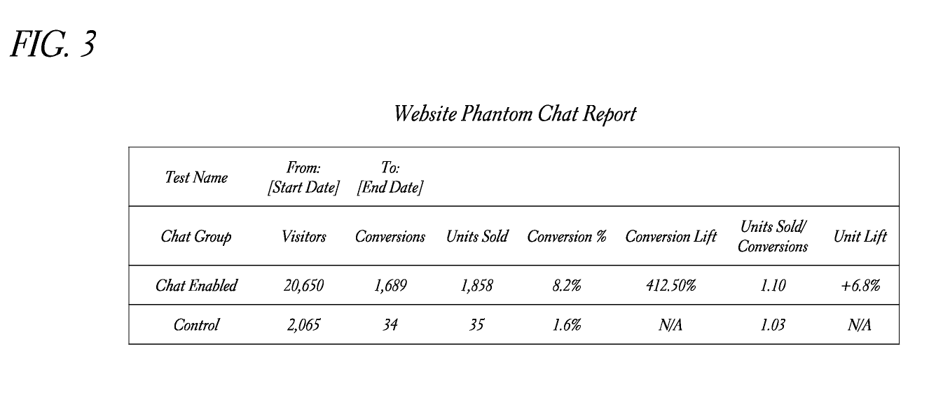

At state 6, data passed to the chat system 102 via the chat beacon(s) is stored in a data warehouse (e.g., the chat system database 104) for later analysis and chat performance reporting, such as for inclusion in the reports discussed below with reference to FIGS. 3-5.

For example, various information that may be indicative of the visitor's interests can be collected (e.g., via the JavaScript tag/beacon) and stored in the visitor browser cookie, the chat database or other data store. This information can include, but is not limited to, some or all of the following:
a unique identifier associated with the visitor and/or the visitor browser; referring information (e.g., referring domain); referring keyword; campaign data (e.g., indicating which advertising campaign/program referred the visitor to the chat enabled website 108); website behavior (e.g., number of visits, time spent on the website, content interest (e.g., as measured by time spent on a given website page having certain content, internal search terms used, number of returning visits to a given page, etc.)); website specific visitor interaction (data a visitor provides via forms and/or other applications on a website that may be indicative of their interests); the Internet Service Provider associated with the visitor; demographic information (e.g., generated based on the visitor's IP address or provided by the chat enabled website based on prior knowledge of the visitor), including some or all of the following: visitor location, language, gender, age, and income.

The following illustrates an example set of parameters for a phantom chat test configuration, although fewer, additional, or different parameters can be used.
Name: [String] (name of the test)
Start date: [date] (start date of the test)
End date: [date] (end date of the test)
Type: [Site(S), Funnel(F), Business Rule(R), Other(O)]
CGP: [Control Group Percentage] (specified percentage of visitors to be selected and placed in the control group)

Phantom chat measurement will now be discussed in greater detail.

For a given website, multiple end-user accessible web pages may contain chat beacons/tags (e.g., all of the end-user accessible web pages or a portion thereof). Website wide phantom chat is optionally measured across the set of all pages on a website that contain chat beacons or a selected portion thereof.

In an example embodiment, during the duration of a phantom chat test, visitors are appropriately grouped if and when, they first encounter a chat beacon/tag on the chat enabled site. The chat system 102 can determine if a visitor is already a participant in a phantom chat test by determining whether the identifier (ID) of the test is already stored on the phantom chat cookie (in which case the visitor is already a participant).

As similarly discussed above, a variety of parameters can be considered in determining which visitors are to be assigned to the control group (e.g., the group provided with phantom chat rather than actual chat), including those factors described above, and in particular, optionally some or all of the following:

The control group can include selected visitors visiting the chat enabled website during certain time periods (e.g., during business hours or outside of business hours); and/or

A specified percentage (CGP) of unassigned visitors can be randomly (wherein the phrase randomly also includes pseudo randomly) selected and placed in the control group. Other visitors are placed in the chat enabled group.

The ID of the test (optionally assigned when the phantom chat test is created) and the visitor group to which the visitor is assigned (either control or chat enabled) are written to a visitor cookie stored in the visitor browser. In an example embodiment, a visitor will retain their group assignment until the end of a rechat interval (described below) or until termination of the test.

As previously discussed, conversion data (e.g., regarding sales conversions and units sold) for some or all visitors, optionally whether or not there was a direct chat interaction, is counted and tracked. The conversion data for the chat enabled group and for the control group (wherein members of the control group are not provided with online chat for a given visit to the website, even though a chat enabled group member would be provided with chat under similar circumstances) can be analyzed and compared to determine the incremental impact of chat on the website.

In addition, the performance of different chat initiation rules can be compared with respect to their effectiveness in making conversions. For example, a first subset of visitors to a website can be assigned to a first group associated with a first set of one or more chat initiation rules, such as those described above. A second subset of visitors to the website can be assigned to second group with a second set of one or more chat initiation rules. The conversion related information (e.g., obtained via the use of beacons, reporting by the website, or otherwise) for the first and second groups is received and stored in memory (e.g., the number of conversions, the number of units sold, whether a form was filled out, whether it was filled out correctly, etc). Conversion related information for the first and second groups is processed so as to provide information as to relative effectiveness of the first set of chat initiation rules and the second set of chat initiation rules in causing conversions. For example, reports can be generated as similarly described above show relative conversions lift, number of conversions per rule set, number of units sold per rule group, etc. Thus, the set of rules that results in the higher conversion rate can be selected for future use.

The foregoing process can optionally be repeated with additional sets of chat initiation rules to further optimize the chat initiation process. Thus, for example, the better of the first and second sets can have its conversion effectiveness tested against a third set of chat initiation rules, and so on.

FIG. 3 illustrates an example report based on results from a chat enabled group and a control group, thereby enabling the operator of a chat enabled website to determine whether and to what degree providing chat facilitates achievement of certain goals of the website. The example report illustrated in FIG. 3 is for a commerce website with an online interactive catalog that has a goal of selling items from the catalog. The report can be presented via a web page, a downloaded data file, a hardcopy printed page, or otherwise.

The illustrated report provides the test name, the test start date, and the test end date. The illustrated example report further provides the number of visitors placed in each group the number of conversions, the number of units sold, the conversion percentage (the number of visitors that made a unit purchase), the conversion lift (the percentage increase in conversion events in the chat enabled group relative to the control group, normalized for the number of members in each group; not provided for the control group), the ratio of units sold to the number of conversions, and the percentage increase in the number of units sold per conversion for the chat enabled group relative to the control group (not provided for the control group), also referred to as the unit lift.

In this example, the conversion lift is the chat enabled group percentage minus the control group percentage divided by the control group percentage ((CE-C)/C).

In addition, the chat system optionally tracks and reports on chat enabled and control group conversions for different funnels. A funnel is used to direct users to accomplish a website goal. A funnel is a series of steps that a website attempts to lead a visitor through culminating in a goal or conversion event. For example, the steps may include product viewed, product added to cart, check out, shipping selection and order confirmation.

Funnel phantom chat is measured across the set of all pages on a website, or a subset thereof, comprising one or more funnels. A beacon is placed on pages that comprise funnels on which the phantom chat test will be run.

In an example embodiment, during the duration of the test, visitors are grouped for a funnel phantom chat test when they first encounter a chat beacon with a funnel ID (e.g., where the beacon is associated with a website web page). The chat system 102 can determine whether a visitor is already a participant in a phantom chat test by determining if a test identifier (ID) is already stored in a funnel phantom chat cookie on the user's terminal.

As similarly discussed above, a variety of parameters can be considered in determining which visitors are to be in the control group (e.g., the group provided with phantom chat rather than actual chat), including some or all of the following:

The control group can be selected from visitors during certain time periods (e.g., during business hours or outside of business hours).

A specified percentage (CGP) of unassigned visitors can be randomly (wherein the phrase randomly also includes pseudo randomly) selected and placed in the control group. Other visitors are placed in the chat enabled group.

The test identifier and visitor group (control or chat enabled) and funnel ID are written to the visitor chat cookie. In an example embodiment, a visitor will retain their group assignment until the end of the rechat interval or termination of the test.

As previously discussed, conversion data (e.g., regarding sales conversions and units sold) for some or all visitors is counted and tracked (optionally whether or not there was a direct chat interaction). The conversion data for the chat enabled group and for the control group (which are not provided with online chat for the website during test) can be analyzed and compared to determine the incremental impact of chat on various funnels associated with the website.

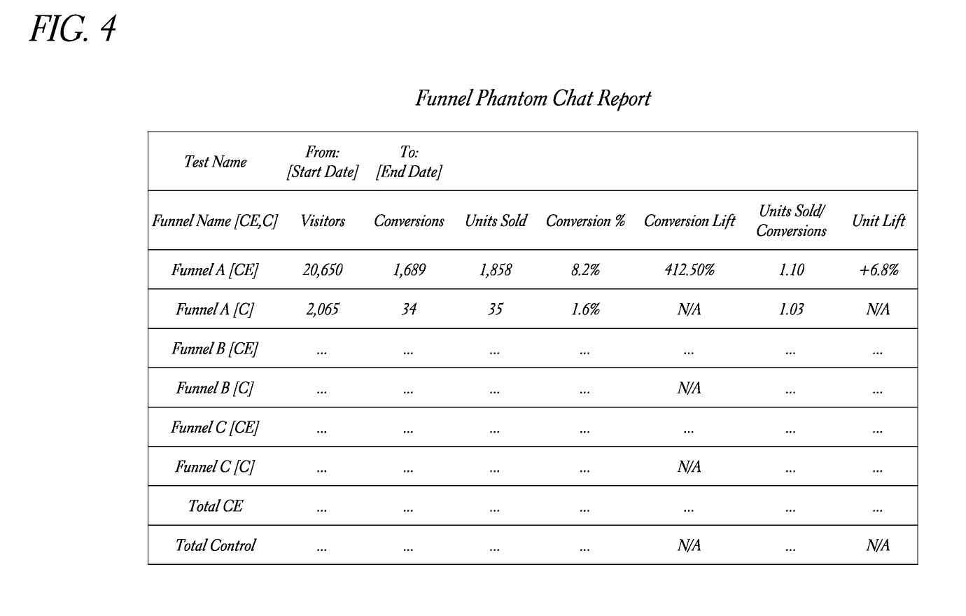

FIG. 4 illustrates an example report based on results from a chat enabled group (“CE”) and a control group (“C”) for a plurality of funnels. Different funnels may result in visitors with different conversion rates. The report provides information on the conversion rates associated with different funnels and on which funnels have relatively higher (or lower) conversion rates when chat is provided. This enables the operator of a chat enabled website to better understand the effectiveness of each funnel (e.g., their conversion rates), and to determine whether and to what degree providing chat facilitates achievement of certain goals within each funnel on a website.

The example report illustrated in FIG. 4 is for a commerce website with an online interactive catalog that has a goal of selling items from the catalog. In addition to the test name, start date, and end date, the report further provides the number of visitors placed in each group (per funnel, the number of conversions, the number of units sold, the conversion percentage (the number of visitors that made a unit purchase), the conversion lift (the percentage increase in conversion events in the chat enabled group relative to the control group, normalized for the number of members in each group; the lift is not provided for the control group), the ratio of units sold to the number of conversions, and the unit lift ((Unit sales for the chat enabled group-Unit sales for control group)/Unit sales for the control group).

Optionally, a user interface is provided (e.g., via a terminal) wherein a user can enter URLs (Uniform Resource Locators) or other identifier associated with a funnel in order to indicate that the funnel is to be included in the report. Other user interfaces, such as a menu of funnels, may be provided via which the user can specify which funnels are to be included in the report. The funnel identifier may be included in one or more beacons embedded on one or more pages.

In addition, reports can be generated with respect to various business rules used to decide when to launch a chat event. As similarly discussed above, different business rules can be used to trigger a chat event. An example report can provide information on the effectiveness of the different rules (as compared to the control group) and on which business rules provide better (or worse) conversion rates relative to other business rules. This can enable the operator of a chat enabled website to better select or define chat launch business rules that result in relatively higher conversion rates.

Thus, for example, business rule phantom chat is measured for one or more rules on a website. In an example embodiment, visitors are grouped (into a control group and a chat enabled group) for a business phantom chat test when they first trigger a business rule during the duration of the test. The chat system 102 can tell if a visitor is already a participant in a phantom chat test by determining whether the identifier (ID) of the test is already stored to the phantom chat cookie.

Certain control groups may be selected to include all or selected missed opportunities. A missed opportunity occurs when a visitor triggers a chat rule, but there are no agents available to chat with the visitor (and so a chat session does not take place). For example, if the control group is selected to include missed opportunities, all missed opportunities, missed opportunities outside of business hours, missed opportunities during business hours, or other subsets of missed opportunities can be specified (e.g., via a user interface, such as a menu).

The control group for business rule phantom chat tracking can be selected to include a percentage of visitors and/or visitors at different times. For example, the control group can be configured to include visitors that visit certain pages of the website during certain periods (e.g., business hours, such as 9:00 AM-5:00 PM or outside of business hours). The CGP percent of the unassigned visitors are optionally randomly selected and placed in the control group. Other visitors are placed in the chat enabled group. The test identifier (test ID), visitor group (control or chat enabled), and the corresponding rule identifier are written to the visitor cookie. In an example embodiment, a visitor will retain their group assignment until the end of the rechat interval or termination of the test.

As previously discussed, conversion data (e.g., regarding sales conversions and units sold) for some or all visitors, optionally whether or not there was a direct chat interaction, is counted and tracked. The conversion data for chat enabled groups and control groups (which are not provided with online chat for the website) can be analyzed and compared to determine the incremental impact of chat for each chat launch rule.

Optionally, a user interface is provided (e.g., via a terminal) wherein a user can enter an identifier associated with a business rule in order to indicate that the business rule is to be included in the report. Other user interfaces, such as a menu of business rules, may be provided via which the user can specify which business rules are to be included in the report.

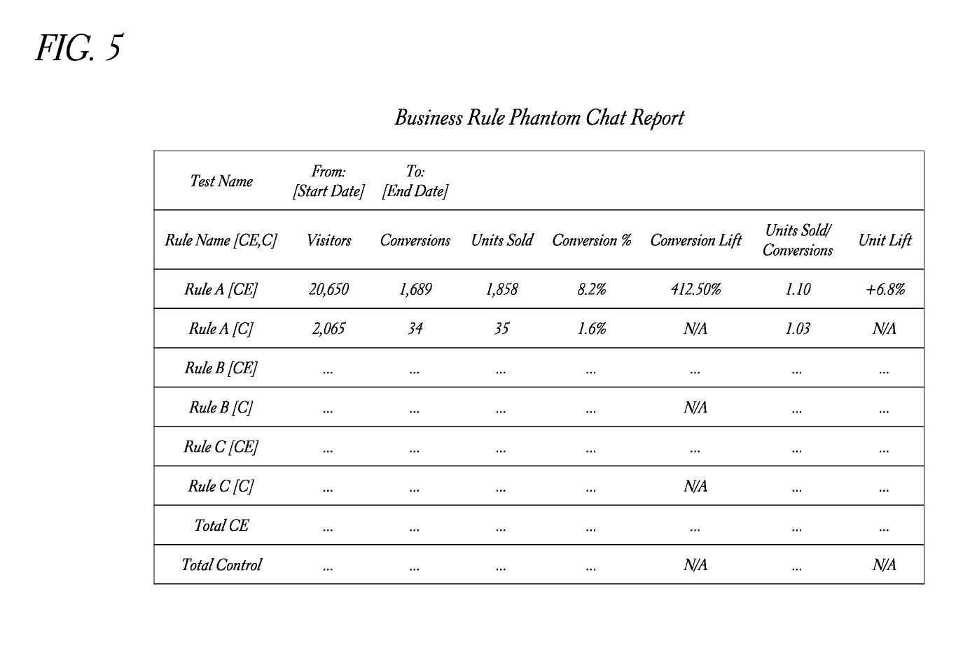

FIG. 5 illustrates an example report based on results from a chat enabled group (“CE”) and a control group (“C”) for a plurality of business rules. The example report illustrated in FIG. 5 is for a commerce website with an online interactive catalog that has a goal of selling items from the catalog. The illustrated report provides the number of visitors placed in each group per rule, the number of conversions, the number of units sold, the conversion percentage (the number of visitors that made a unit purchase), the conversion lift (the percentage increase in conversion events in the chat enabled group relative to the control group, normalized for the number of members in each group; not provided for the control group), the ratio of units sold to the number of conversions, and the percentage increase in the number of units sold per conversion for the chat enabled group relative to the control group (not provided for the control group), also referred to as the unit lift.

With respect to the foregoing reports illustrated in FIGS. 3-5, fewer, additional, or different types of information can be reported as well. For example, the value of units sold (e.g., the dollar value), gross margin of units, total revenue, and/or other metrics could be included. While the reports illustrated in FIGS. 3-5 are for a website whose goal is to sell units, other reports can be generated for other goals. For example, if the goal is to have visitors fill out a form, reports can be generated providing information regarding how providing online chat affects the percentage of visitors that complete the form.

In addition, while reference may be made to utilizing beacons and JavaScript tags in order to track sales, other techniques can be used as well or instead. For example, sales can be measured by retrieving sales information in batch mode periodically (e.g., at the end of the day) and using a session ID to matchup phantom chats and live chats to their prospective sales.

Further, while reference may be made to using beacons and tags to collect data, other techniques may be used as well. For example, log file analysis may be performed to collect such data.

Thus, as described herein, methods and systems are provided for measuring the approximate effectiveness of chat services provided on a website with respect to achieving one or more goals. In addition, methods and systems are described for determining the effectiveness of various funnels and chat triggering business rules in achieving one or more goals.

It should be understood that certain variations and modifications of this invention would suggest themselves to one of ordinary skill in the art. The scope of the present invention is not to be limited by the illustrations or the foregoing descriptions thereof.

What is claimed is:

1. A method of measuring networked chat performance, the method comprising:
for a plurality of visitors to a website, assigning a first subset of the visitors to a control group, wherein members of the control group are not to be provided with online chat during at least one visit to the website based at least in part on their assignment to the control group, and
wherein other visitors in the plurality of visitors that are not in the control group are eligible to receive chat services during at least one visit to the website;
causing at least in part:
a control group indicator, and
a web beacon
to be stored on at least a portion of visitor terminals associated with corresponding members of the control group, wherein the control group indicator indicates or can be used to determine that the corresponding visitor is a member of the control group;
receiving first data from at least a portion of the beacons indicating which visitors in the control group made a purchase and so were converted during a first period of time;
receiving second data indicating which of the visitors that are not in the control group made a purchase and so were converted during the first period of time; and
causing at least in part the first data and the second data to be processed so as to provide information as to a difference in conversion rates for the control group relative to the visitors that are not in the control group and that received chat service to thereby provide a measure as to the effect chat has on conversions.

2. The method as defined in claim 1, wherein a predetermined percentage of visitors visiting at least a portion of the website during the first period of time are assigned to the control group.

3. The method as defined in claim 1, the method further comprising generating a report including at least the following information:
an indication as to how many members are in the control group;
an indication as to how many visitors in the plurality of visitors are not in the control group;
the number of conversions for the control group;
the number of conversions for visitors in the plurality of visitors that are not in the control group;
the number of units sold via the website to the control group; and
the number of units sold via the website visitors in the plurality of visitors that are not in the control group.

4. The method as defined in claim 1, the method further comprising generating a report including at least a ratio of units sold to the number of conversions for the control group.

5. The method as defined in claim 1, the method further comprising:
for a first funnel and a second funnel associated with the website, receiving an indication as to:
which conversions for the control group are associated with the first funnel;
which conversions for the control group are associated with the second funnel;
which conversions are associated with the first funnel for visitors in the plurality of visitors that are not in the control group;
which conversions are associated with the second funnel for visitors in the plurality of visitors that are not in the control group; and
providing an indication as to the relative impact of chat on the conversion rate of the first funnel and the second funnel.
providing information related to the relative affect of chat on the conversion rate of the first funnel and the second funnel.

6. The method as defined in claim 1, the method further comprising:
for a first chat launch rule and a second chat launch rule associated with the website, receiving an indication as to:
how many conversions are associated with the first chat launch rule;
how many conversions are associated with the second chat launch rule; and
providing an indication as to which of the first chat launch rule and the second chat launch rule is associated with a higher conversion rate.
providing information regarding the relative impact of chat on the conversion rate of the first chat launch rule and the second chat launch rule.

7. A method of measuring the effect of online chat, the method comprising:
defining a first subset of website visitors that are not to be provided with online chat while a chat evaluation process is being conducting;
causing at least in part one or more indicators to be stored indicating which visitors are associated with the first subset;
causing at least in part the first subset of the visitors not to be provided with online chat during one or more visits to the website, wherein other visitors in the plurality of visitors that are not in the first subset are eligible to receive chat service during at least one visit to the website;
receiving first data indicating which visitors in the first subset of visitors were converted via the website during a first period of time;
receiving second data indicating which of the visitors that are not in the first subset of visitors and that received chat service were converted via the website during the first period of time; and
causing at least in part the first data and the second data to be processed so as to provide information to a user as to what portion of the visitors in the first subset were converted during the first period of time and to provide information as to what portion of the visitors that are not in the first subset of visitors and that received chat service were converted via the website during the first period of time.

8. The method as defined in claim 7, wherein at least a first visitor is converted by making a purchase via the website.

9. The method as defined in claim 7, wherein at least a first visitor is converted by filing out a form provided by the website.

10. The method as defined in claim 7, the method further comprising downloading a beacon to a terminal associated with at least one visitor in the first subset, wherein the beacon indicates when a purchase has been made from the website.

11. The method as defined in claim 7, wherein at least a predetermined percentage of visitors visiting at least a portion of the website during the first period of time are associated with the first subset.

12. The method as defined in claim 7, the method further comprising generating a report including at least the following information:
an indication as to how many members are in the first subset;
an indication as to how many visitors received chat service during the first period of time;
the number of visitors in the first subset that made a purchase via the website during the first period of time;
the number of visitors that received chat service and that made a purchase via the website during the first period of time;
the number of units sold via the website to the visitors in the first subset; and
the number of units sold via the website to the visitors that received chat service during the first period of time.

13. The method as defined in claim 7, the method further comprising generating a report including at least a ratio of units sold to the number of purchases made by visitors in the first subset.

14. The method as defined in claim 7, the method further comprising:
for a first funnel and a second funnel associated with the website, receiving an indication as to:
which conversions for the visitors in the first subset are associated with the first funnel;
which conversions for the visitors in the first subset are associated with the second funnel;
which conversions are associated with the first funnel for visitors that received chat service;
which conversions are associated with the second funnel for visitors that received chat service; and
providing information related to the relative affect of chat on the conversion rate of the first funnel and the second funnel.

15. The method as defined in claim 7, the method further comprising comparing the conversion rates for the first group to the second group.

16. The method as defined in claim 7, the method further comprising:
for a first chat launch rule and a second chat launch rule associated with the website, receiving an indication as to:
how many conversions are associated with the first chat launch rule;
how many conversions are associated with the second chat launch rule; and
providing an indication as to the relative conversion rates associated with the first chat launch rule and the second chat launch rule.

17. A system for measuring the effect of online chat, the system comprising:
computer readable medium that stores programmatic code that is configured to:
assign a first subset of visitors to a website to a control group, wherein the control group is not to be provided with online chat in order to measure chat effectiveness;
receive and store conversion related information for the first subset of visitors;
receive and store conversion related information for other visitors to the website that did engage in online chat during a time period when the first subset of visitors was not provided with online via the website; and
cause at least in part the conversion related information for the first subset of visitors and the conversion related information for other visitors to the website that did engage in online chat to be processed so as to provide information as to a difference in conversion rates for the control group relative to the visitors that are not in the control group and that received chat service to thereby provide a measure as to the effect chat has on conversions.

18. The system as defined in claim 17, wherein the program code is further configured to cause at least in part an activator monitor to be transferred to terminals associated with visitors in the first subset, wherein the activator monitor indicates when a purchase has been made from the website.

19. The system as defined in claim 18, wherein the activity monitor is a web beacon.

20. The system as defined in claim 17, wherein the program code is further configured to associate at least a predetermined percentage of visitors visiting at least a portion of the website during the first period with the first subset.

21. The system as defined in claim 17, wherein the program code is further configured to generate a report that includes at least the following information:
an indication as to how many members are in the first subset;
an indication as to how many visitors received chat service during the first period of time;
the number of visitors in the first subset that made a purchase via the website during the first period of time; and
the number of visitors that received chat service and that made a purchase via the website during the first period of time.

22. The system as defined in claim 17, wherein the program code is further configured to generate a report that includes at least a ratio of units sold to the number of purchases made by visitors in the first subset.
The system as defined in claim 17, wherein the program code is further configured to, for a first funnel and a second funnel associated with the website, receive an indication as to:
which conversions for the visitors in the first subset are associated with the first funnel;
which conversions for the visitors in the first subset are associated with the second funnel;
which conversions are associated with the first funnel for visitors that received chat service;
which conversions are associated with the second funnel for visitors that received chat service; and
provide an indication related to the conversion rate effectiveness of the first funnel and the second funnel.

23. The system as defined in claim 17, wherein the program code is further configured to, for a first chat launch rule and a second chat launch rule associated with the website, receive an indication as to:
how many conversions are associated with the first chat launch rule;
how many conversions are associated with the second chat launch rule; and
providing an indication as to the relative conversion rates associated with the first chat launch rule and the second chat launch rule.

24. A method of measuring networked chat performance, the method comprising:
assigning a first subset of visitors to a website to a control group, wherein in order to measure chat effectiveness, the control group is not provided with online chat;
receiving and storing conversion related information for the first subset of visitors;
receiving and storing conversion related information for other visitors to the website that did engage in online chat during a time period when the first subset of visitors was not provided with online via the website; and
causing at least in part the conversion related information for the first subset of visitors and the conversion related information for other visitors to the website that did engage in online chat to be processed so as to provide information as to a difference in conversion rates for the control group relative to the visitors that are not in the control group and that received chat service to thereby provide a measure as to the effect chat has on conversions.

25. The method as defined in claim 24, wherein at least a first visitor is converted by making a purchase via the website.

26. The method as defined in claim 24, wherein at least a first visitor is converted by filing out a form provided by the website.

27. The method as defined in claim 24, the method further comprising causing at least in part a beacon to be provided to a browser with a website visitor, wherein the beacon indicates when a purchase has been made from the website.

28. The method as defined in claim 24, wherein at least a predetermined percentage of visitors visiting at least a portion of the website during a first period of time are associated with the first subset.

29. The method as defined in claim 24, the method further comprising generating a report including at least the following information:
an indication as to how many members are in the first subset;
an indication as to how many visitors received chat service during a first period of time;
the number of visitors in the first subset that made a purchase via the website during the first period of time; and
the number of visitors that received chat service and that made a purchase via the website during the first period of time.

30. The method as defined in claim 24, the method further comprising generating a report including at least a ratio of units sold to the number of purchases made by visitors in the first subset.

31. The method as defined in claim 24, the method further comprising:
for a first funnel and a second funnel associated with the website, receiving an indication as to:
which conversions for the visitors in the first subset are associated with the first funnel;
which conversions for the visitors in the first subset are associated with the second funnel;
which conversions are associated with the first funnel for visitors that received chat service;
which conversions are associated with the second funnel for visitors that received chat service; and
providing an indication related to the conversion rate effectiveness of the first funnel and the second funnel.

32. The method as defined in claim 24, the method further comprising:
for a first chat launch rule and a second chat launch rule associated with the website, receiving an indication as to:
how many conversions are associated with the first chat launch rule;
how many conversions are associated with the second chat launch rule; and
providing an indication as to the relative conversion rates associated with the first chat launch rule and the second chat launch rule.

33. The method as defined in claim 24, the method further comprising storing a rechat interval for a first visitor, the rechat interval specifying a time period in which online chat is not to be initiated with the first visitor, but in which the visitor can initiate an online chat.

34. The method as defined in claim 24, the method further comprising initiating a chat with a first visitor based at least in part on the first visitor's behavior on the website.

35. The method as defined in claim 24, the method further comprising initiating a chat with a first visitor based at least in part on how much time the first visitor has been at a first web page.

36. The method as defined in claim 24, the method further comprising initiating a chat with a first visitor based at least in part on a sequence of web pages visited by the first visitor.

37. The method as defined in claim 24, the method further comprising initiating a chat with a first visitor based at least in part on how many times a web pages has been visited by the first visitor.

38. The method as defined in claim 24, the method further comprising initiating a chat with a first visitor based at least in part on an exit of a web page by the first visitor.

39. The method as defined in claim 24, the method further comprising initiating a chat with a first visitor based at least in part on determining that the first visitor has not completed a form within a specified period of time.

40. The method as defined in claim 24, the method further comprising initiating a chat with a first visitor based at least in part on determining that the first visitor has not correctly completed a form.

41. The method as defined in claim 24, the method further comprising initiating a chat with a first visitor based at least in part on referring information including some or all of the following: a search term, campaign information, or a referring domain.

42. The method as defined in claim 24, the method further comprising initiating a chat with a first visitor based at least in part demographic information associated with the first visitor.

43. The method as defined in claim 24, the method further comprising initiating a chat with a first visitor based at least in part on customer account information associated with the first visitor.

44. The method as defined in claim 43, wherein the customer account information includes purchase history information and/or preference information.

45. The method as defined in claim 24, the method further comprising initiating a chat with a first visitor based at least in part on information provided by the first visitor about the first visitor.

46. The method as defined in claim 24, the method further comprising initiating a chat with a first visitor based at least in part on a search term used by the first visitor.

47. A method of measuring networked chat performance, the method comprising:
assigning a first subset of visitors to a website to a first group, the first group associated with a first set of one or more chat initiation rules;
assigning a second subset of visitors to the website to a second group, the second group associated with a second set of one or more chat initiation rules;
receiving and storing conversion related information for the first group;
receiving and storing conversion related information for the second group; and
causing at least in part the conversion related information for the first group and the conversion related information for the second group to be processed so as to provide information as to relative effectiveness of the first set and the second set with respect to conversions.

48. The method as defined in claim 47, the method further comprising:
based at least in part on a determination as to which of the first set and the second set provides for a higher conversion rate,
assigning a third subset of visitors to the website to a third group, the third group associated with the set of one or more chat initiation rules that provided the higher conversion rate;
assigning a fourth subset of visitors to the website to a fourth group, the fourth group associated with a third set of one or more chat initiation rules;
receiving and storing conversion related information for the first group;
receiving and storing conversion related information for the second group; and
causing at least in part the conversion related information for the third group and the conversion related information for the fourth group to be processed so as to provide information as to relative effectiveness of the third set of one or more chat initiation rules and whichever of the first set and second set which was determined to have provided the higher conversion rate.

49. The method as defined in claim 47, the method further comprising performing a plurality of comparisons as to the conversion effectiveness of different chat initiation rules.

50. The method as defined in claim 47, wherein the first set of chat initiation rules includes a rule related to a visitor's behavior on the website.

51. The method as defined in claim 47, wherein the first set of chat initiation rules includes a rule related to how much time a visitor has been at a first web page.

52. The method as defined in claim 47, wherein the first set of chat initiation rules includes a rule related to a sequence of web pages visited by a visitor.

53. The method as defined in claim 47, wherein the first set of chat initiation rules includes a rule related to how many times a web pages has been visited by a visitor.

54. The method as defined in claim 47, wherein the first set of chat initiation rules includes a rule related to an exit of a web page by a visitor.

55. The method as defined in claim 47, wherein the first set of chat initiation rules includes a rule related to determining that a visitor has not completed a form within a specified period of time.

56. The method as defined in claim 47, wherein the first set of chat initiation rules includes a rule related to determining that a visitor has not correctly completed a form.

57. The method as defined in claim 47, wherein the first set of chat initiation rules includes a rule related to referring information including some or all of the following: a search term, campaign information, or a referring domain.

58. The method as defined in claim 47, wherein the first set of chat initiation rules includes a rule related to demographic information associated with a visitor.

59. The method as defined in claim 47, wherein the first set of chat initiation rules includes a rule related to customer account information associated with a visitor.

60. The method as defined in claim 59, wherein the customer account information includes purchase history information and/or preference information.

61. The method as defined in claim 47, wherein the first set of chat initiation rules includes a rule related to information provided by a visitor about a visitor.

62. The method as defined in claim 47, wherein the first set of chat initiation rules includes a rule related to a search term used by a visitor.
